(19) United States
(12) Patent Application Publication
(10) Pub. No.: US 2026/0085477 A1
(43) Pub. Date: Mar. 26, 2026

(54) Vibratory Plate with One-Piece Protective Cover

(71) Applicant: Wacker Neuson Produktion GmbH & Co. KG, Reichertshofen (DE)

(72) Inventors: Ferdinand Rupp, Oberguenzburg (DE); Walter Unverdorben, Markt Indersdorf (DE)

(21) Appl. No.: 19/340,357

(22) Filed: Sep. 25, 2025

(30) Foreign Application Priority Data
Sep. 26, 2024 (DE) 102024127906.0

(51) Int. Cl. E01C 19/38; B06B 1/16; E01C 19/35; E02D 3/074

(52) U.S. Cl. CPC E01C 19/38; B06B 1/16; E01C 19/35; E02D 3/074

(57) ABSTRACT

A vibrating plate for compacting a floor has an upper mass; a lower mass movable relative to the upper mass; a vibration exciter for generating vibrations for compacting the floor; and a vibration decoupling device arranged between the upper mass and the lower mass. The the upper mass has components selected from the group consisting of a drive for driving the vibration exciter, an energy storage for the drive, a frequency converter, and electronic components. The lower mass has a floor contact plate for introducing the vibrations into the floor to be compacted. The vibration decoupling device has a plurality of attachment points to which the upper mass is attached. The upper mass has a one-piece shell body that at least partially encloses at least some of the components of the upper mass and that is attached to the vibration decoupling device at the attachment points.

### BACKGROUND OF THE INVENTION

### 1. Field of the Invention

The invention relates to a vibration plate for compacting a floor. In particular, the invention also relates to a reversible vibration plate with a rechargeable battery and an electric drive.

### 2. Description of the Related Art

Vibration plates, often also referred to as vibratory plates, are known as floor compacting devices for compacting a floor. They generally have an upper mass and a lower mass that can be moved relative to the upper mass. A vibration exciter is provided on the lower mass, which can be used to generate vibrations for floor compaction. A vibration decoupling device, e.g. in the form of rubber buffers, is arranged between the upper mass and the lower mass in order to decouple the upper mass from the vibrations generated at the lower mass.

Various concepts are known for the drive of the vibration exciter. For example, a combustion motor can be provided on the upper mass, which drives the vibration exciter located on the lower mass via a belt drive or a hydraulic drive. Increasingly, electric drives are also known, which can be arranged directly on the vibration exciter at the upper mass or also at the lower mass. A battery serving as an electrical energy storage unit can then be provided for the electric drive, particularly on the upper mass. To provide a current suitable for the electric drive, a converter device, e.g. a frequency converter, can be provided between the battery and the electric drive.

Solutions in which one or more unbalance shafts are set in rotation to generate the desired vibrations have proven themselves as vibration exciters. Vibration exciters with two parallel and counter-rotating unbalance shafts are often used. By changing the phase position of the counter-rotating unbalance shafts, a resulting force vector can be changed, particularly with regard to its direction. This makes it possible to move the vibration plate forwards and backwards (reversible vibration plate).

The upper mass is decoupled from the lower mass by means of a vibration decoupling device to prevent the strong vibrations generated at the lower mass from affecting the upper mass unhindered. In practice, the vibration decoupling device is often realized by mounting rubber buffers between the upper mass and the lower mass. In the prior art, the upper mass often has a carrying platform on which the drive components, e.g. a combustion motor or a battery, can be mounted. This platform is usually designed as a cast part or sheet metal part.

The drive components on the upper mass should be protected from dirt and mechanical impact. An additional protective frame can be attached to the upper mass for this purpose. The protective frame is usually designed as a welded assembly made of bent semi-finished products and sheet metal, which is surface-coated and usually has additionally mounted sheet metal or plastic components. In addition, the protective frame allows the entire machine to be lifted using a lifting eye. The protective frame also allows access to the drive components via openings, e.g. for refueling, checking the oil level or replacing the battery. Finally, the protective frame also gives the machine an attractive appearance.

A vibration plate of this type is known from EP 3 862 487 A1. FIG. 1, which is incorporated by reference herein and which shows an example from this previous publication.

The vibration plate shown in FIG. 1 has an upper mass 1 and a lower mass 2 movable relative to the upper mass 1. The lower mass 2 is coupled to the upper mass 1 via rubber buffers 3 serving as a vibration decoupling device. In this manner, the strong vibrations generated at the lower mass 2 are only transmitted to the upper mass 1 in a damped manner.

The upper mass 1 has a platform or carrier frame 4 on which a battery 5 and a converter 6 are mounted, which are also assigned to the upper mass 1. The battery 5 and the converter 6 are enclosed in a protective frame 7.

The battery 5 is replaceable and can be replaced by another battery if necessary. For this purpose, a plug connector is provided on the converter 6 or on the converter housing belonging to the converter 6, to which the battery 5 can be plugged.

The lower mass 2 has a floor contact plate 9, which can be used to compact the floor underneath. A vibration exciter or unbalance exciter 10, which also belongs to the lower mass 2, is arranged on the upper side of the floor contact plate 9.

In the prior art, such unbalance exciters are usually driven in rotation by motors, in particular combustion motors, which are arranged on the upper mass. In the case of the vibration plate in FIG. 1, however, an electric motor not shown is integrated directly into the unbalance exciter 10, i.e. arranged on the lower mass.

A guide drawbar 11 is attached to the upper mass 2 or the carrier frame 4 to guide the vibration plate.

FIG. 2 shows another example, which is known from DE 10 2020 111 123 A1, which is incorporated by reference herein. Functionally identical components to the vibration plate in FIG. 1 are marked with the same reference signs.

A protective frame 7 is also provided on this vibration plate, which is attached to the carrier frame 4 of the upper mass 1 in the form of two curved tubes. The two curved tubes can be supported against one another by one or more transverse carriers not shown. The protective frame 7 encloses a cover 13, under which components of the drive are concealed.

The different superstructures and variants of protective frames and covers in the prior art are expensive to manufacture. The design as a welded assembly gives a fragmented, jagged impression, making it difficult to achieve an attractive appearance. In addition, a large number of components have to be screwed onto the usual platform of the upper mass, which requires the domes to be machined and can therefore also lead to higher manufacturing costs.

### SUMMARY OF THE INVENTION

The invention is based on the object of providing a vibration plate with an improved protective cover which offers effective protection of the components of the upper mass against mechanical impact and soiling, while at the same time allowing a high level of functional integration and cost-effective manufacturability.

The object is achieved by a vibration plate having the features of claim 1. Advantageous embodiments are given in the dependent claims.

A vibration plate for compacting a floor is disclosed, having an upper mass; having a lower mass movable relative to the upper mass; having a vibration exciter provided on the lower mass for generating vibrations for compacting the floor; and having a vibration decoupling device arranged between the upper mass and the lower mass; wherein the upper mass has components selected from the group consisting of a drive for driving the vibration exciter, energy storage for the drive, frequency converter, electronic components; wherein the lower mass comprises a floor contact plate for introducing the vibrations into the floor to be compacted; wherein the vibration decoupling device comprises a plurality of attachment points to which the upper mass is attached; wherein the upper mass comprises a one-piece shell body; wherein the shell body at least partially encloses at least a portion of the components of the upper mass; wherein the shell body is attached to the lower mass; and wherein the vibration decoupling device is arranged in the force flow path between the shell body and the lower mass.

The shell body can be attached to the vibration decoupling device at the attachment points. Alternatively, an intermediate element belonging to the upper mass, e.g. a carrier platform, can be provided, which is attached to the attachment points of the vibration decoupling device and which supports the shell body.

As a vibration decoupling device, rubber buffers can be used in a known manner, each of which provides an attachment point at which the corresponding connection points of the upper mass can be connected to the lower mass. For example, the vibration decoupling device may have four rubber buffers provided at the four corners of the lower mass, providing the attachment points to which the shell body of the upper mass is attached. The rubber buffers can be attached, in particular screwed, to the corresponding attachment points of the lower mass and the upper mass.

In one variant, the intermediate element (e.g. the carrier platform) can be attached to the rubber buffers, while the shell body is attached to the intermediate element.

In each of these variants, the vibration decoupling device (e.g. the rubber buffers) is arranged in the force flow path between the shell body and the lower mass.

An electric battery can be used as an energy storage if the vibration exciter is driven by an electric drive (electric motor). Alternatively, the energy storage can also be provided as a fuel tank if a combustion motor is provided as the drive.

The battery can be replaceable or permanently mounted. If the battery is interchangeable, a battery holder can be provided into which the battery can be inserted on the upper mass.

In particular with an electric drive, it is possible to arrange it either on the upper mass or alternatively on the lower mass, directly on or close to the vibration exciter.

The one-piece shell body, which forms a kind of protective cover on the upper mass, is substantially part of the invention. It can be designed as a part, in particular as a cast part, to which all relevant components of the upper mass can be attached, e.g. the drive (electric motor or combustion motor), the energy storage, a frequency converter or electronic components.

The shell body can be designed like a protective cover and enclose the respective components like a hood or turtle shell. Accordingly, the components are arranged inside the shell body to enable the protective effect of the shell body to unfold.

The shell body can have corner areas and wall areas in between. The shell body can have a dome-like structure so that it can be slipped over the components and cover them.

The shell body can preferably be a one-piece casting, wherein connecting surfaces for other components can be machined if necessary.

As a robust shell body, it can enclose the components of the upper mass. It can be mounted on the four rubber buffers (main buffers) of the vibration decoupling device, for example, and bolted to them. The cover can be designed as a machined, painted cast part.

The shell body can enclose a shell space in which the components of the upper mass are arranged. The shell space forms a spanned space that can be approximated to a cuboid or a prism. The components of the upper mass are protected in this space.

The shell body can fulfill at least one of the following conditions:
The height of the shell body is at least 30%, in particular at least 40%, in particular at least 50%, in particular at least 60% of the maximum length of the shell body;
The height of the shell body is no more than 70% of the maximum length of the shell body;
The height of the shell body is at least 50%, in particular at least 60%, in particular at least 70%, in particular at least 80%, in particular at least 100% of the maximum width of the shell body.

The height is understood to be the maximum height, i.e. the vertical distance between the lowest and highest point of the shell body when installed.

The shell body can have a drawbar connection for attaching a guide drawbar. The drawbar connection can be suitable for having a so-called drawbar block attached to it, which then carries the actual guide drawbar that can be pivoted relative to the drawbar block. Alternatively, the drawbar block can also be integrated directly into the shell body and thus serve as a drawbar connection. The guide drawbar can then be pivotably attached directly to the shell body.

A carrier platform can be attached to the underside of the shell body to carry a battery serving as an energy storage for the drive. For example, a solid carrier plate can be screwed onto the inside of the shell body from below as a carrier platform, onto which the battery mounting and, if necessary, an optional air duct can be screwed. This also provides a cost-effective mounting option for the frequency converter and other electronic components, which are protected from above by the shell body as a protective cover. From below, the carrier platform protects against dirt from below, for example.

In one embodiment, the carrier platform may have at least two levels, wherein one of the levels may be a higher level at a higher elevation, at which the carrier platform is connected to the shell body, and wherein the other of the levels may be a lower level at a lower elevation, at which the battery may be arranged. Accordingly, the carrier platform can have a recess which is designed, for example, in such a manner that it is arranged between two vibration exciters or unbalance shafts provided on the lower mass. This means that the battery can be placed very low on this recess in the carrier platform, which enables the vibration plate to be set up low overall. The vibration plate can therefore be designed to be very flat compared to conventional vibration plates.

The carrier platform can be attached to the underside of the shell body and supported by it. The carrier platform can in turn carry the battery, for example. The shell body can in turn be supported at the attachment points of the vibration decoupling device.

In one variant, the carrier platform can be supported at the attachment points of the vibration decoupling device, while the shell body is attached to and supported by the carrier platform.

At least one battery opening can be provided on an upper side of the shell body for removing or inserting a battery serving as an energy storage. The battery can then be housed in the space enclosed by the shell body, e.g. in a battery holder. To remove or replace the battery, it can be removed from the top through the shell body via the battery opening.

The battery opening can be covered by an elastic cover. The elastic cover can be designed as an elastomer cover, for example. It can, for example, take the form of an elastic “flap” that is attached to the shell body on one side and rests loosely on the other. The cover can rest sufficiently on the top of the shell body simply due to its own weight and remain there reliably even when the vibration plate is in vibration mode.

The cover can have ribbing on its underside facing the shell space of the shell body. In particular, the cover can have ribbing on its underside facing the inside of the shell body in order to prevent the cover from sagging. The cover is stabilized and stiffened accordingly by the ribbing.

The ribbing on the cover can be designed in such a manner that it is supported on the battery when it is ready for operation, i.e. with a battery installed. As explained above, the battery can either be permanently installed or replaceable and inserted in a battery holder. The elastic cover can be supported directly on the battery with its ribbing and is therefore securely fixed.

The ribbing may have at least two ribs on the underside of the cover, wherein the distance between the two ribs is such that a space formed between them is sufficient to accommodate a carrying handle of the battery. For use in a vibration plate, it is necessary that the battery has a sufficiently high capacity. Accordingly, it cannot be avoided that the battery has a considerable weight. In order to be able to handle it comfortably, it is known to provide a carrying handle in the area of the top of the battery, which allows the battery to be carried comfortably. If the ribbing on the elastic cover is suitably designed, the carrying handle of the battery can be positioned exactly between the two ribs of the ribbing. This additionally secures the battery in position and supports the elastic cover on the top of the battery. Of course, other ribs can form the ribbing in addition to the two ribs mentioned.

In addition to the battery opening, one or more openings can be provided on the top of the shell body, which can be covered in a similar manner by an elastic cover.

A lifting eye can be provided on the shell body. The lifting eye can be provided in particular on the top of the shell body. The lifting eye can be formed in one piece directly on the shell body. Alternatively, the lifting eye can also be a separate part attached to the shell body. In particular, the lifting eye can also be swivel-mounted as a separate part on the shell body in order to be swiveled up only when needed. If the lifting eye is not required, it can be swiveled into a rest position.

It may be useful to provide reinforcement in the area of the lifting eye or in the area where the lifting eye is attached to the shell body on the underside of the lifting eye connection, e.g. with reinforced ribs.

A lashing device can be provided on the outside of the shell body. The lashing device can, for example, have several, in particular four lashing eyes, which are provided at the four corners of the shell body. The lashing eyes can be integrated directly into the shell body, i.e. be an integral part of the shell body itself. The lashing eyes are therefore not additional components that are provided in addition to the shell body. The lashing eyes can be positioned on the shell body in such a manner that they are covered by the elastic cover of the battery opening in a normal operating state of the vibration plate.

At least one cooling air opening can be provided in the shell body for the passage of cooling air. The cooling air opening can form a cooling air inlet or a cooling air outlet. The cooling air can be fed into the interior under the shell body, for example, to cool the battery, the frequency converter or the drive.

The shell body forms a large part of the mass of the upper mass. If the shell body is designed as a casting, it is easy to influence the machine'′ center of gravity, i.e. the center of gravity of the entire vibration plate, during the design phase by designing the casting accordingly.

The shell body with its openings can be designed in such a manner that it can be molded or demolded vertically during production. The mold then requires no further cores. Undercuts are avoided.

### BRIEF DESCRIPTION OF THE DRAWINGS

These and other advantages and features of the invention are explained in more detail below by means of examples with the aid of the accompanying figures. In the figures:

FIG. 1 is a vibration plate according to the prior art, and is appropriately labeled “PRIOR ART”;

FIG. 2 is another example of a vibration plate according to the prior art, and is appropriately labeled “PRIOR ART”;

FIG. 3 is a vibration plate according to the invention;

FIG. 4 is a sectional side view of the vibration plate in FIG. 3;

FIG. 5 is a sectional enlargement of FIG. 4;

FIG. 6 is the vibration plate in oblique top view, with the covers removed;

FIG. 7 is a shell body in perspective view from the front;

FIG. 8 is a perspective view of the shell body from behind;

FIG. 9 is a view of a variant of the vibration plate with a two-level carrier platform; and

FIG. 10 view of is an inner area of the upper mass with the shell body removed.

### DETAILED DESCRIPTION

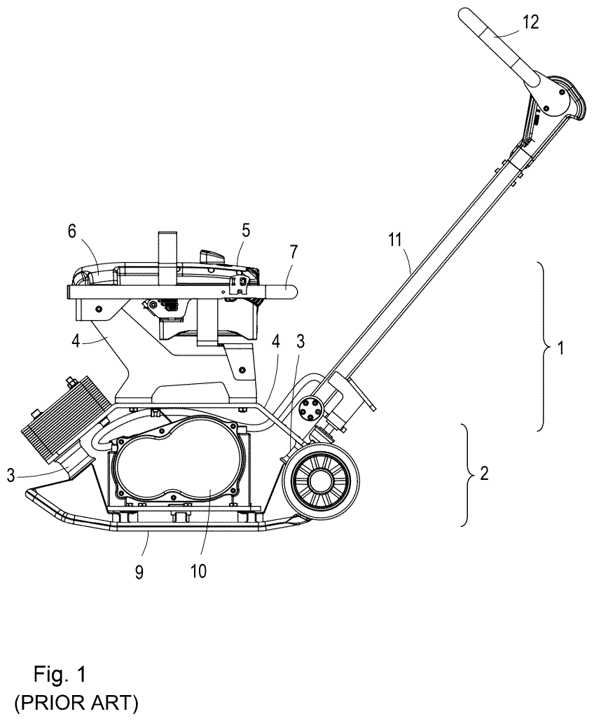

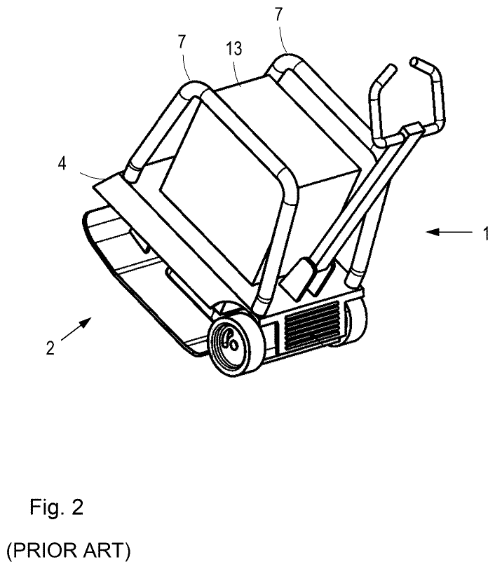

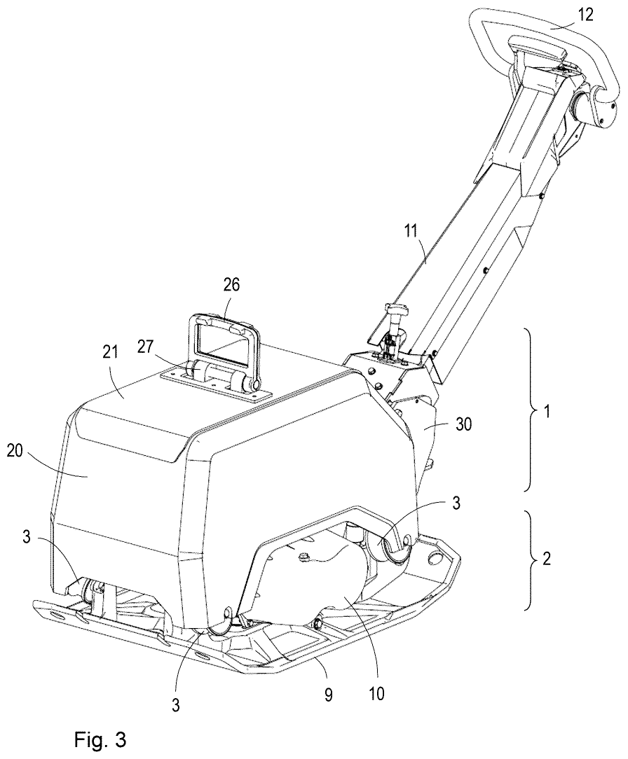

FIG. 3 shows an example of a vibration plate according to the invention. Insofar as components perform similar or identical functions to the vibration plates according to the prior art explained above with reference to FIGS. 1 and 2, the same reference symbols are used. Some of these components are not explained again. Accordingly, the vibration plate according to the invention also has an upper mass 1 and a lower mass 2. The lower mass 2 is coupled to the upper mass 1 at a total of four corners via rubber buffers 3 that serve as vibration decoupling devices.

An unbalance exciter 10 serving as a vibration exciter is provided on the lower mass 2. The unbalance exciter 10 in the example shown is a twin-shaft exciter with two counter-rotating unbalance shafts (not shown), which are set in rotation by an electric motor (not shown) in order to generate vibrations for floor compaction.

A substantially important component of the upper mass 1 for the invention is a shell body 20, which surrounds the sensitive components of the upper mass 1 and is attached to the rubber buffers 3 at the four corner points. In contrast to the prior art, no welded or tubular construction is thus provided on the upper mass 1 as a protective frame, but rather a solid protective shell as the shell body 20.

In the variant shown in FIG. 3, the shell body 20 is attached directly to the rubber buffers 3. In a variant not shown, an intermediate element, e.g. a carrier platform explained later, can be provided, which is attached to the rubber buffers 3 and in turn supports the shell body 20.

The shell body 20 has corner areas and flat wall areas arranged between them, which give the shell body 20 an attractive appearance. The shell body 20 is designed as a cast part and thus represents an effective mass for stabilizing the upper mass 1 in order to compensate for the strong vibrations of the lower mass 2.

An elastomer cover 21 is attached to the upper mass 1, which covers openings on the top of the shell body 20 similar to a heavy cloth or rag. The elastomer cover 21 can be lifted or folded up, particularly in the front area (left side in FIG. 3) and in the rear area on the side of the shell body 20 facing the guide drawbar 11. The elastomer cover 21 can cover the entire top of the shell body 20 as one part. However, it can also be realized by several individual, separate covers.

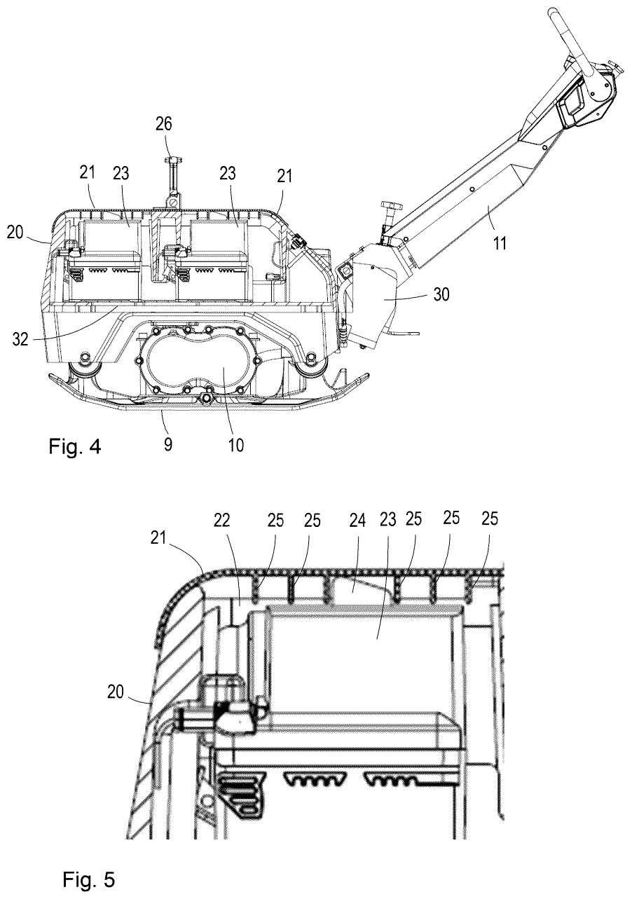

FIG. 4 shows a side sectional view of the vibration plate in FIG. 3. FIG. 5 shows an enlarged section of FIG. 4.

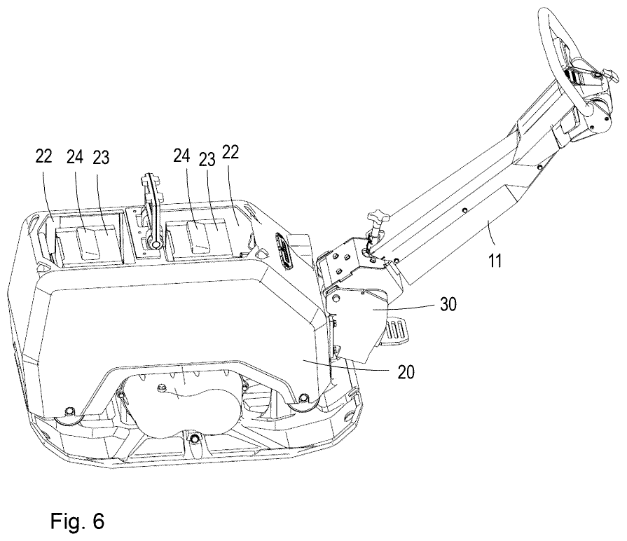

FIG. 6 shows an oblique top view of the vibration plate with the elastomer cover 21 removed. Accordingly, two openings 22 can be seen in FIG. 6, which are covered by the elastomer cover 21 in FIG. 3.

FIGS. 4 to 6 show two rechargeable batteries 23, which can be inserted in corresponding battery holders on the upper mass 1 and are used to supply the electric motor, which is not shown, with electrical energy as a drive for the unbalance exciter 10. The batteries 23 can be removed upwards via the two openings 22. For this purpose, a handle 24 is provided on the top of each of the rechargeable batteries 23, by which the battery 23 can be conveniently gripped and lifted.

FIG. 5 is an enlargement of FIG. 4 and shows that several ribs 25 are provided on the underside of the elastomer cover 21 to reinforce and stiffen the elastomer cover 21. The ribs 25 serve to ensure that the elastic elastomer cover 21 does not sag due to its own weight, but has a certain rigidity.

In addition, the height of some of the ribs 25 is such that they are supported on the top of the battery 23 inserted underneath. In this manner, a form-locking support of the elastomer cover 21 on the respective battery 23 is achieved.

In addition, two of the ribs 25 have a distance between them that is dimensioned in such a manner that the handle 24 of the battery 23 fits between them (FIG. 5). This can also stiffen and stabilize the elastomer cover 21.

A lifting eye 26 is arranged on the upper side of the shell body, which is pivotably mounted on a lifting eye holder 27. The lifting eye holder 27 can be part of the shell body 20, i.e. formed in one piece with it.

As FIG. 4 shows, a carrier platform 32 is inserted and fastened from below on the underside of the shell body 20, on which further components can be mounted that are to be protected by the shell body 20.

In the example shown in FIG. 4, the carrier platform 32 is supported by the shell body 20. In a variant not shown, it is possible that the carrier platform 32 provided below the shell body 20 is attached to the rubber buffers 3 and in turn supports the shell body 20.

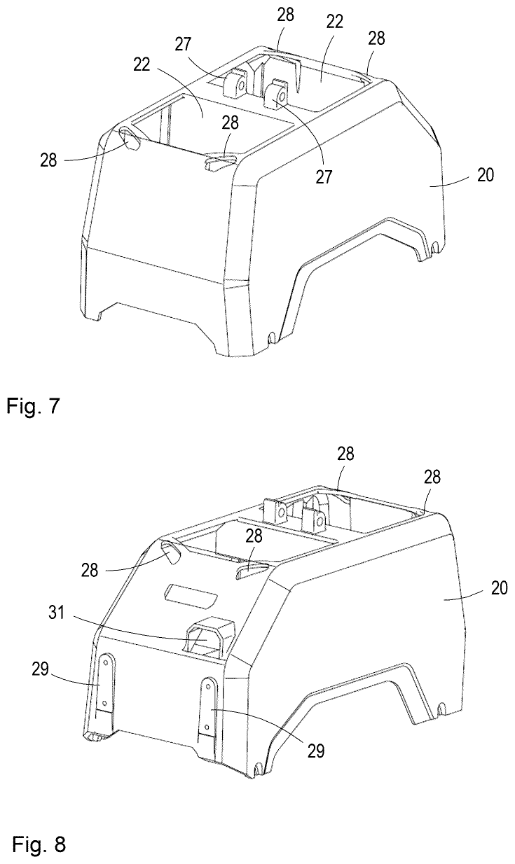

FIGS. 7 and 8 show the shell body 20 from the front (FIG. 7) and from the rear (FIG. 8).

It can be seen that the shell body 20 forms a protective cover which, similar to a turtle shell, encloses an interior space (shell space) in which components of the vibration plate, in particular the batteries 23, but also other electronic components and, for example, a frequency converter, are housed.

### In Addition, the Lifting Eye Holder 27 Is Formed on the Upper Side As Part of the Cast shell body 20.

In addition, two, i.e. a total of four, lashing eyes 28 are formed on each of the two end faces, which are covered by the elastomer cover 21 in the normal operating state. By lifting off the elastomer cover 21, the four lashing eyes 28 are exposed so that suitable lashing straps can be threaded through to secure the vibration plate for transportation. The lashing eyes 28 are formed on the upper side of the shell body 20 and are therefore higher than most drop sides of loading platforms. To gain access to the lashing eyes 28, the ends of the elastomer cover 21 must be lifted slightly.

In the rear area - viewed in the direction of travel - the shell body 20 has a drawbar connection 29 in the form of suitable contact surfaces. A drawbar block 30 can be screwed on there, which supports the guide drawbar 11 in a manner known per se (see FIGS. 3 and 4).

At least one cooling air opening 31 (FIG. 8) is formed on the shell body 20, via which cooling air can enter the interior of the shell body 20 in order to cool the electronic components provided there.

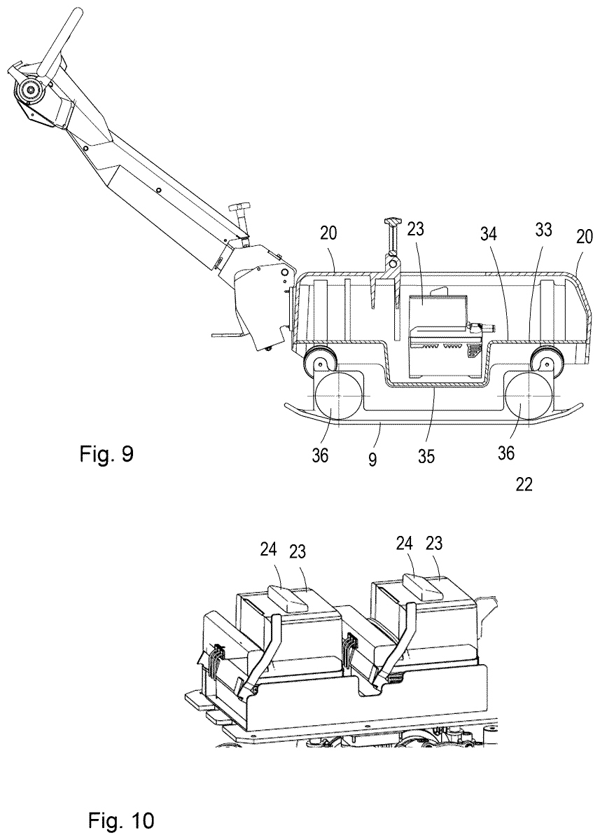

FIG. 9 shows a variant of the vibration plate in FIG. 3.

A carrier platform 33 is attached to the underside of the shell body 20. The carrier platform 33 in FIG. 9 differs from the carrier platform 32 shown in FIG. 4 in that it is two-level or has two levels. An upper level 34 is used to attach the carrier platform 33 to the shell body 20 from below. A lower level 35, located at a lower height, forms a recess in which the battery 23 and other components can be accommodated. The carrier platform 33 is thus “bulged” downwards in order to lower the battery 23. This allows the entire design of the vibration plate to be changed and, in particular, the overall height to be reduced.

Instead of a uniform unbalance exciter 10 (FIG. 4), two unbalance exciters 36 are provided as vibration exciters in the variant shown in FIG. 9. In particular, these may be single-shaft exciters arranged at a distance from one another to allow an intermediate or free space for the lower level 35 of the carrier platform 33, which is located lower down.

With this variant, a significantly lower design can be achieved than with the vibration plate in FIG. 3.

FIG. 10 shows an interior view of the components in the shell space under the shell body 20, with the two batteries 23 and other electronic components.

1. A vibration plate for compacting a floor, comprising:
an upper mass;
a lower mass that is movable relative to the upper mass;
a vibration exciter that is configured to generate vibrations for floor compaction; and
a vibration decoupling device that is arranged between the upper mass and the lower mass;
wherein
the upper mass has components selected from the group consisting of a drive that is configured to drive the vibration exciter, an energy storage that is configured to supply power to the drive, a frequency converter, and electronic components;
the lower mass has a floor contact plate that is configured to introduce vibrations into the floor to be compacted;
the vibration decoupling device has several attachment points to which the upper mass is attached;
the upper mass has a one-piece shell body;
the shell body at least partially encloses at least some of the components of the upper mass;
the shell body is attached to the lower mass; and wherein
the vibration decoupling device is arranged in a force flow path between the shell body and the lower mass.

2. The vibration plate according to claim 1, wherein the shell body is attached to the vibration decoupling device at the attachment points.

3. The vibration plate according to claim 1, wherein the shell body encloses a shell space in which the components of the upper mass are arranged.

4. The vibration plate according to claim 1, wherein the shell body fulfills at least one of the following conditions:
a height of the shell body is at least 30%of a maximum length of the shell body;
the height of the shell body is no more than 70% of the maximum length of the shell body;
the height of the shell body is at least 50% of a maximum width of the shell body.

5. The vibration plate according to claim 4, wherein the height of the shell body is at last 40% of the maximum length of the shell body.

6. The vibration plate according to claim 5, wherein the height of the shell body is at last 60% of the maximum length of the shell body.

7. The vibration plate according to claim 6, wherein the height of the shell body is at least 50% of the maximum width of the shell body.

8. The vibration plate according to claim 7, wherein the height of the shell body is at least 100% of the maximum width of the shell body.

9. The vibration plate according to claim 1, wherein the shell body comprises a drawbar connection for attaching a guide drawbar.

10. The vibration plate according to claim 1, wherein a carrier platform is attached to an underside of the shell body and is configured to carry a battery serving as the energy storage for the drive.

11. The vibration plate according to claim 1, wherein
the carrier platform has at least two levels;
one of the levels is a higher level than a level at which the carrier platform is connected to the shell body ; and wherein
the other of the levels is a lower level than a level on which the battery is arranged.

12. The vibration plate according to claim 1, wherein at least one battery opening is provided on an upper side of the shell body (20), for removing a battery serving as energy storage.

13. The vibration plate according to claim 12, wherein the battery opening is coverable by an elastic cover.

14. The vibration plate according to claim 3, wherein the cover has a ribbing on an underside thereof that is directed towards the shell space of the shell body.

15. The vibration plate according to claim 14, wherein the ribbing is designed such that, when readied for operation with a built-in battery, it rests on the battery.

16. The vibration plate according to claim 14, wherein
the ribbing comprises at least two ribs on an underside of the cover; and wherein
a distance between the two ribs is dimensioned in such a manner that a space formed between the two ribs is sufficient to accommodate a carrying handle of the battery.

17. The vibration plate according to claim 1, further comprising a lifting eye that is provided on the shell body.

18. The vibration plate according claim 1, further comprising a lashing device that is provided on an outside of the shell body.

19. The vibration plate according to claim 1, wherein at least one cooling air opening is provided in the shell body for the passage of cooling air.
